(19) United States
(12) Patent Application Publication
(10) Pub. No.: US 2022/0227106 A1
(43) Pub. Date: Jul. 21, 2022

(54) THERMALLY CONDUCTIVE AND ELECTRICALLY INSULATING SUBSTRATE STRUCTURE AND METHOD FOR MANUFACTURING THE SAME

(71) Applicant: AMULAIRE THERMAL TECHNOLOGY, INC., New Taipei City (TW)

(72) Inventors: CHING-MING YANG, New Taipei City (TW); TZE-YANG YEH, New Taipei City (TW)

(21) Appl. No.: 17/153,827

(22) Filed: Jan. 20, 2021

(51) Int. Cl. B32B 15/092; B32B 18/00; B32B 27/30

(52) U.S. Cl. CPC B32B 15/092; B32B 18/00; B32B 2307/752; B32B 2307/302; B32B 2307/206; B32B 27/304

(57) ABSTRACT

A thermally conductive and electrically insulating substrate structure and a method for manufacturing the same are provided. The thermally conductive and electrically insulating substrate structure includes an insulating layer, a plurality of metal layers and a plurality of function layers. The plurality of metal layers and the plurality of function layers are disposed on the insulating layer. A sidewall of the metal layer is in contact with a corresponding one of the function layers, and two of the function layers between any two adjacent ones of the metal layers are not in contact with each other.

### FIELD OF THE DISCLOSURE

The present disclosure relates to a substrate structure and a method for manufacturing the same, and more particularly to a thermally conductive and electrically insulating substrate structure and a method for manufacturing the same.

### BACKGROUND OF THE DISCLOSURE

Current electronic components in power modules of electric vehicles/hybrid vehicles have very high power, so that the thickness of a copper layer in an insulating metal substrate needs to be increased to improve an effect of heat dissipation.

The current direct plated copper (DPC) technology can more easily achieve a production of thick copper than the common direct bonded copper (DBC) technology, but it is difficult to produce a patterned copper layer by etching when the copper layer is too thick.

In addition, reference is made to FIG. 1, which illustrates an existing insulating metal substrate structure, and a circuit design that causes a gap between copper layers 20A to be narrower than a spacing G on an insulating layer 10A. When a voltage is high, electrons will be discharged from a sidewall of one copper layer 20A to a sidewall of the other copper layer 20A, resulting in a short circuit.

### SUMMARY OF THE DISCLOSURE

In response to the above-referenced technical inadequacies, the present disclosure provides a thermally conductive and electrically insulating substrate structure and a method for manufacturing the same.

In one aspect, the present disclosure provides a thermally conductive and electrically insulating substrate structure, including an insulating layer, a plurality of metal layers and a plurality of function layers. The plurality of metal layers and the plurality of function layers are disposed on the insulating layer, a sidewall of the metal layer is in contact with a corresponding one of the function layers, and two of the function layers between any two adjacent ones of the metal layers are not in contact.

In certain embodiments, the function layer is made of a highly insulating material.

In certain embodiments, the function layer is made of a polymeric material.

In certain embodiments, the function layer is made of a low-binding polymeric material.

In certain embodiments, the function layer is made of a corrosion resistant material.

In certain embodiments, the function layer is a composite layer, which includes a ceramic layer formed on the sidewall of the metal layer and a polymer layer formed on a sidewall of the ceramic layer, and the polymer layer is made of a low-binding polymeric material.

In another aspect, the present disclosure provides a thermally conductive and electrically insulating substrate structure, including an insulating layer, a plurality of metal layers, a plurality of function layers and a framework. The plurality of metal layers, the plurality of function layers and the framework are disposed on the insulating layer, a sidewall of the metal layers is in contact with a corresponding one of the function layers, and two of the function layers between any two adjacent ones of the metal layers are in contact with the framework.

In certain embodiments, the function layer is made of a highly insulating material.

In certain embodiments, the function layer is made of a polymeric material.

In certain embodiments, the function layer is made of a high-binding polymeric material.

In certain embodiments, the function layer is made of a corrosion resistant material.

In certain embodiments, the function layer is a composite layer, which includes a ceramic layer formed on the sidewall of the metal layer and a polymer layer formed on a sidewall of the ceramic layer, and the polymer layer is made of a high-binding polymeric material.

In certain embodiments, the framework is made of a non-metallic material with a low electrical conductivity.

In yet another aspect, the present disclosure provides a method for manufacturing a thermally conductive and electrically insulating substrate structure, including steps of: (a) attaching a plurality of function layers to sidewalls of a plurality of metal layers; (b) attaching a framework between any two adjacent ones of the function layers; and (c) attaching the framework and the plurality of metal layers on an insulating layer.

In certain embodiments, the method for manufacturing a thermally conductive and electrically insulating substrate structure further includes a step (d): removing the framework.

In certain embodiments, in the step (d) the framework is removed by corrosion and the function layer is made of a corrosion resistant material.

In certain embodiments, in the step (d) the framework is removed by peeling and the function layer is made of a low-binding polymeric material.

In certain embodiments, the function layer is a composite layer, which includes a ceramic layer formed on the sidewall of the metal layer and a polymer layer formed on a sidewall of the ceramic layer.

In certain embodiments, the framework is made of a non-metallic material with a low electrical conductivity.

In certain embodiments, a manner of attachment is by physical bonding or chemical molding.

Therefore, the thermally conductive and electrically insulating substrate structure provided by the present disclosure can effectively reduce the probability of short circuit by virtue of “the plurality of metal layers and the plurality of function layers being disposed on the insulating layer, a sidewall of the metal layer being in contact with a corresponding one of the function layers, and two of the function layers between any two adjacent ones of the metal layers not being in contact with each other.”

These and other aspects of the present disclosure will become apparent from the following description of the embodiment taken in conjunction with the following drawings and their captions, although variations and modifications therein may be affected without departing from the spirit and scope of the novel concepts of the disclosure.

### BRIEF DESCRIPTION OF THE DRAWINGS

The present disclosure will become more fully understood from the following detailed description and accompanying drawings in which:

FIG. 1 is a schematic side view of an electrically insulating metal substrate structure of the prior art.

FIG. 2 is a schematic side view of a thermally conductive and electrically insulating metal substrate structure according to a first embodiment of the present disclosure.

FIG. 3 is a schematic side view of a thermally conductive and electrically insulating metal substrate structure according to a second embodiment of the present disclosure.

FIG. 4 is a schematic side view of a thermally conductive and electrically insulating metal substrate structure according to a third embodiment of the present disclosure.

FIG. 5A to FIG. 5C are schematic views of a method for manufacturing a thermally conductive and electrically insulating substrate structure according to a fourth embodiment of the present disclosure.

FIG. 6A to FIG. 6D are schematic views of a method for manufacturing a thermally conductive and electrically insulating substrate structure according to a fifth embodiment of the present disclosure.

FIG. 7A to FIG. 7C are schematic views of a method for manufacturing a thermally conductive and electrically insulating substrate structure according to a sixth embodiment of the present disclosure.

FIG. 8A to FIG. 8C are schematic views of a method for manufacturing a thermally conductive and electrically insulating substrate structure according to a seventh embodiment of the present disclosure.

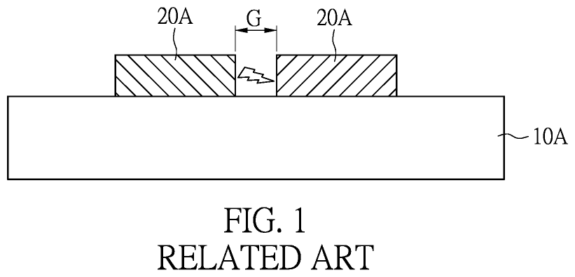

### DETAILED DESCRIPTION OF THE EXEMPLARY EMBODIMENTS

The present disclosure is more particularly described in the following examples that are intended as illustrative only since numerous modifications and variations therein will be apparent to those skilled in the art. Like numbers in the drawings indicate like components throughout the views. As used in the description herein and throughout the claims that follow, unless the context clearly dictates otherwise, the meaning of “a”, “an”, and “the” includes plural reference, and the meaning of “in” includes “in” and “on”. Titles or subtitles can be used herein for the convenience of a reader, which shall have no influence on the scope of the present disclosure.

The terms used herein generally have their ordinary meanings in the art. In the case of conflict, the present document, including any definitions given herein, will prevail. The same thing can be expressed in more than one way. Alternative language and synonyms can be used for any term(s) discussed herein, and no special significance is to be placed upon whether a term is elaborated or discussed herein. A recital of one or more synonyms does not exclude the use of other synonyms. The use of examples anywhere in this specification including examples of any terms is illustrative only, and in no way limits the scope and meaning of the present disclosure or of any exemplified term. Likewise, the present disclosure is not limited to various embodiments given herein. Numbering terms such as “first”, “second” or “third” can be used to describe various components, signals or the like, which are for distinguishing one component/signal from another one only, and are not intended to, nor should be construed to impose any substantive limitations on the components, signals or the like.

### First Embodiment

Referring to FIG. 2, a first embodiment of the present disclosure provides a thermally conductive and electrically insulating substrate structure. As shown in the figure, the thermally conductive and electrically insulating substrate structure according to the first embodiment of the present disclosure includes an insulating layer 10, a plurality of metal layers 20 and a plurality of function layers 30.

As mentioned above, the plurality of metal layers 20 and the plurality of function layers 30 are disposed on the insulating layer 10, a sidewall of the metal layer 20 is in contact with a corresponding one of the function layers 30, and two of the function layers 30 between any two adjacent ones of the metal layers 20 are not in contact. The number of the plurality of metal layers 20 in the present embodiment is illustrated as two, but the plurality of metal layers 20 can also be more than two. In another embodiment, the plurality of metal layers 20 can also be formed as a predetermined pattern. In the present embodiment, the function layer 30 has a function to prevent the occurrence of electricity tripping off between any two adjacent ones of the metal layers 20.

Further, when a distance between any two adjacent ones of the metal layers 20 is narrow due to a circuit design, and when the voltage is high, electrons will be discharged from the sidewall of one metal layer 20 to the sidewall of the other metal layer 20, resulting in a short circuit. Therefore, the function layer 30 is made of a highly insulating material, such as a metal oxide (aluminum oxide, copper oxide, silicon oxide, etc.) or a polymeric material (such as epoxy resin, polytetrafluoroethylene, etc.), which can effectively reduce the probability of short circuits.

### Second Embodiment

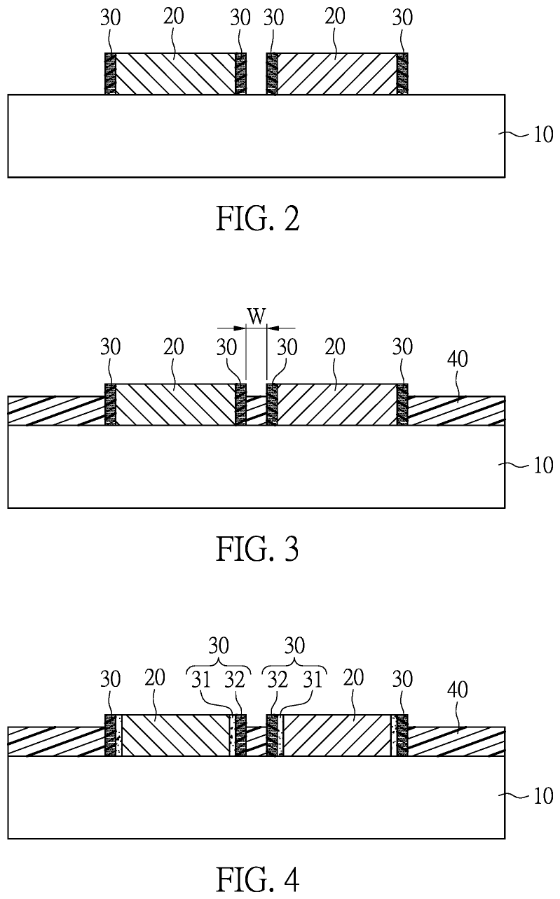

Referring to FIG. 3, a second embodiment of the present disclosure provides a thermally conductive and electrically insulating substrate structure. As shown in the figure, the thermally conductive and electrically insulating substrate structure according to the second embodiment of the present disclosure includes an insulating layer 10, a plurality of metal layers 20, a plurality of function layers 30 and a framework 40.

As mentioned above, the plurality of metal layers 20, the plurality of function layers 30 and the framework 40 are disposed on the insulating layer 10, a sidewall of the metal layer 20 is in contact with a corresponding one of the function layers 30, and two of the function layers 30 between any two adjacent ones of the metal layers 20 are in contact with the framework 40. A shape of the framework 40 can be varied as needed, and is not limited thereto. In the present embodiment, the framework 40 has a function of accurately controlling a width of a line.

Further, when a width W of the framework 40 between any two adjacent ones of the metal layers 20 is narrow due to a circuit design, and when the voltage is high, electrons will be discharged from the sidewall of one metal layer 20 to the sidewall of the other metal layer 20, resulting in a short circuit. Therefore, the function layer 30 is made of a highly insulating material, such as a metal oxide (aluminum oxide, copper oxide, silicon oxide, etc.) or a polymeric material (such as epoxy resin, polytetrafluoroethylene, etc.), which can effectively reduce the probability of short circuits.

Moreover, under the circumstances that the framework 40 does not need to be removed, the function layer 30 can be made of a high-binding polymeric material, such as an epoxy resin, to increase bonding to the framework 40, so as to prevent the framework 40 from falling off. In addition, the framework 40 can be made of a non-metallic material with a low electrical conductivity, such as polytetrafluoroethylene.

### Third Embodiment

Referring to FIG. 4, a third embodiment of the present disclosure provides a thermally conductive and electrically insulating substrate structure. As shown in the figure, the thermally conductive and electrically insulating substrate structure according to the third embodiment of the present disclosure includes an insulating layer 10, a plurality of metal layers 20, a plurality of function layers 30 and a framework 40.

In the present embodiment, the function layer 30 can be a composite layer. Further, the function layer 30 can contain a ceramic layer 31 formed on a sidewall of the metal layer 20 to increase insulation, and a polymer layer 32 formed on a sidewall of the ceramic layer 31 to increase a bonding strength to the framework 40.

In another embodiment, under the circumstances that the framework 40 is to be removed, the function layer 30 can be made of a low-binding polymeric material, such as a special type of silicone, so that the framework 40 can be easily peeled off.

In another embodiment, under the circumstances that the framework 40 is to be removed by a chemical method, the function layer 30 can be made of a corrosion resistant material, such as a ceramic material (aluminum oxide, copper oxide, silicon oxide, etc.), to reduce lateral erosion caused by the chemical fluid.

### Fourth Embodiment

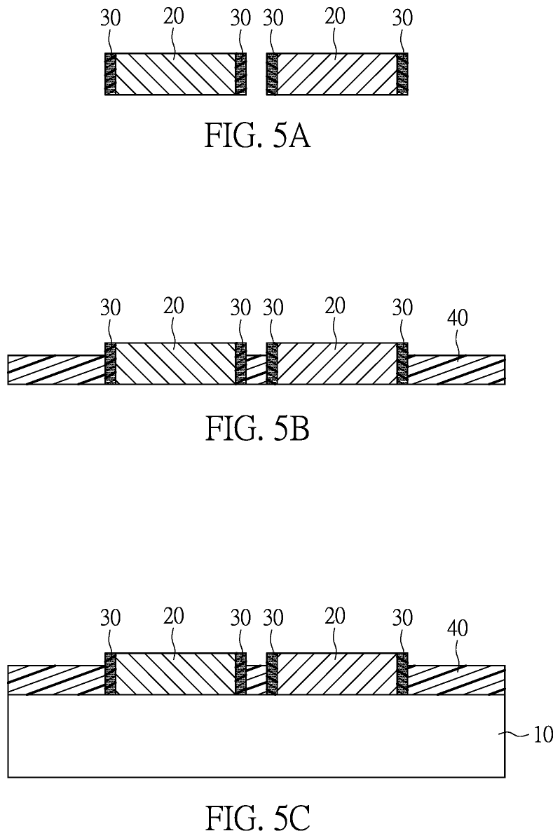

Referring to FIG. 5A to FIG. 5C, a fourth embodiment of the present disclosure provides a method for manufacturing a thermally conductive and electrically insulating substrate structure, including steps of:

(a) attaching a plurality of function layers 30 to sidewalls of a plurality of metal layers 20;

(b) attaching a framework 40 between any two adjacent ones of the function layers 30; and

(c) attaching the framework 40 and the plurality of metal layers 20 on an insulating layer 10.

Further, a manner of attachment can be by physical bonding or chemical molding. For example, the metal layer 20 can be attached to the insulating layer 10 by means of a pressed alloy sheet/block, spraying, plating, or other physical or chemical means.

The function layer 30 can be made of a highly insulating material, such as a metal oxide (aluminum oxide, copper oxide, silicon oxide, etc.) or a polymeric material (such as epoxy resin, polytetrafluoroethylene, etc.), which can effectively reduce the probability of short circuit.

Under the circumstances that the framework 40 does not need to be removed, the functional layer 30 can be made of a high-binding polymeric material, such as an epoxy resin, to increase a bonding strength to the framework 40, so as to prevent the framework 40 from falling off. In addition, the framework 40 can be made of a non-metallic material with a low electrical conductivity, such as polytetrafluoroethylene. Moreover, the function layer 30 can be a composite layer. Further, the function layer 30 can include a ceramic layer 31 attached to a sidewall of the metal layer 20 and a polymer layer 32 attached to a sidewall of the ceramic layer 31, and the polymer layer is made of a high-binding polymeric material.

### Fifth Embodiment

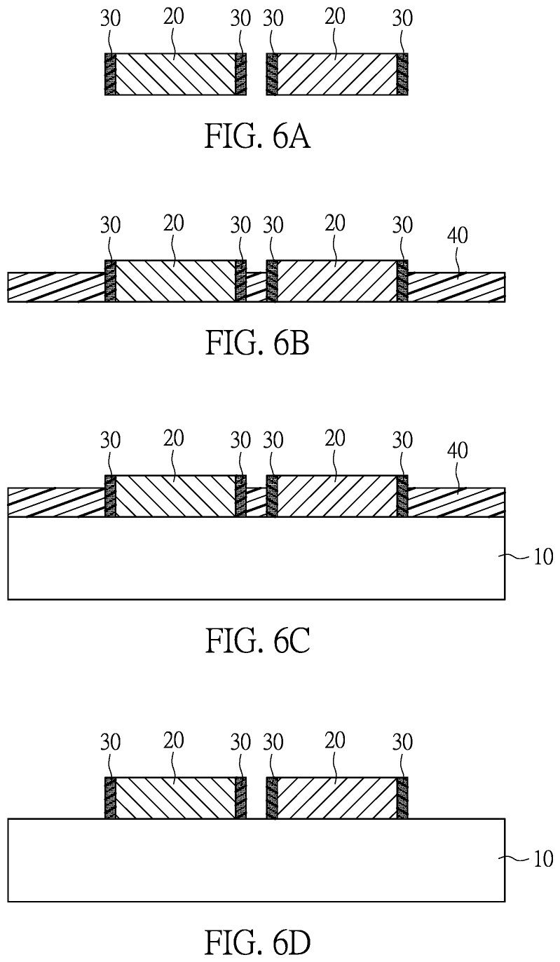

Referring to FIG. 6A to FIG. 6D, a fifth embodiment of the present disclosure provides a method for manufacturing a thermally conductive and electrically insulating substrate structure, including steps of:

(a) attaching a plurality of function layers 30 to sidewalls of a plurality of metal layers 20;

(b) attaching a framework 40 between any two adjacent ones of the function layers 30;

(c) attaching the framework 40 and the plurality of metal layers 20 on an insulating layer 10; and

(d) removing the framework 40.

Further, the framework 40 can be removed by physical or chemical removal. For example, the framework 40 can be removed by corrosion, and when the framework 40 is to be removed by corrosion, the function layer 30 can be made of a corrosion resistant material to reduce lateral erosion caused by the corrosion.

In addition, the framework 40 can be removed by peeling, and when the framework 40 is to be removed by peeling, the function layer 30 can be made of a low-binding polymeric material, so that the framework 40 can be easily peeled off.

It should be noted that the above is to describe the differences between the present embodiment and other embodiments, and similarities therebetween will not be repeated.

### Sixth Embodiment

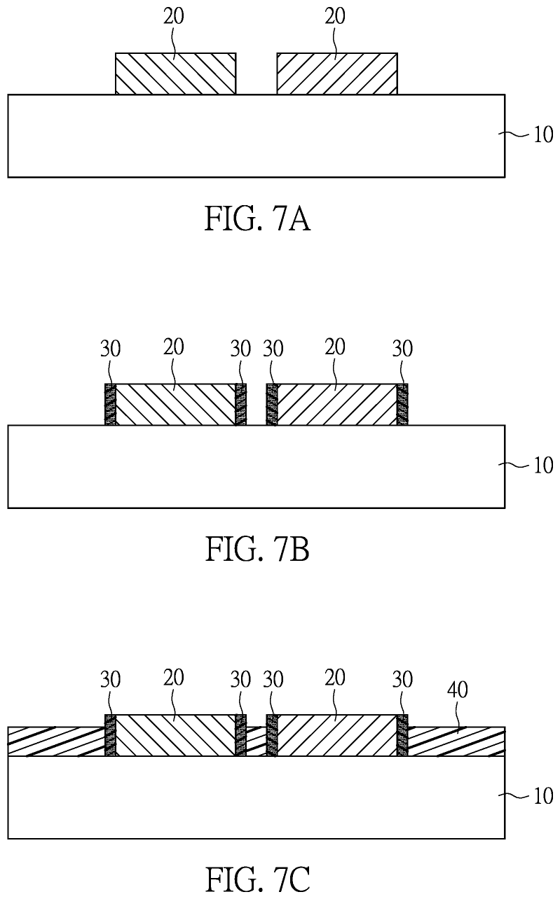

Referring to FIG. 7A to FIG. 7C, a sixth embodiment of the present disclosure provides a method for manufacturing a thermally conductive and electrically insulating substrate structure, including steps of:

(a) attaching a plurality of metal layers 20 to an insulating layer 10;

(b) attaching a plurality of function layers 30 to sidewalls of the plurality of metal layers 20; and

(c) attaching a framework 40 between any two adjacent ones of the function layers 30 and to the insulating layer 10.

Further, the attaching method can be by physical bonding or chemical molding. In addition, under the circumstances that the framework 40 does not need to be removed, the functional layer 30 in the present embodiment can be made of a high-binding polymeric material and the framework 40 can be made of a non-metallic material with a low electrical conductivity.

It should be noted that the above is to describe the differences between the present embodiment and other embodiments, and similarities therebetween will not be repeated.

### Seventh Embodiment

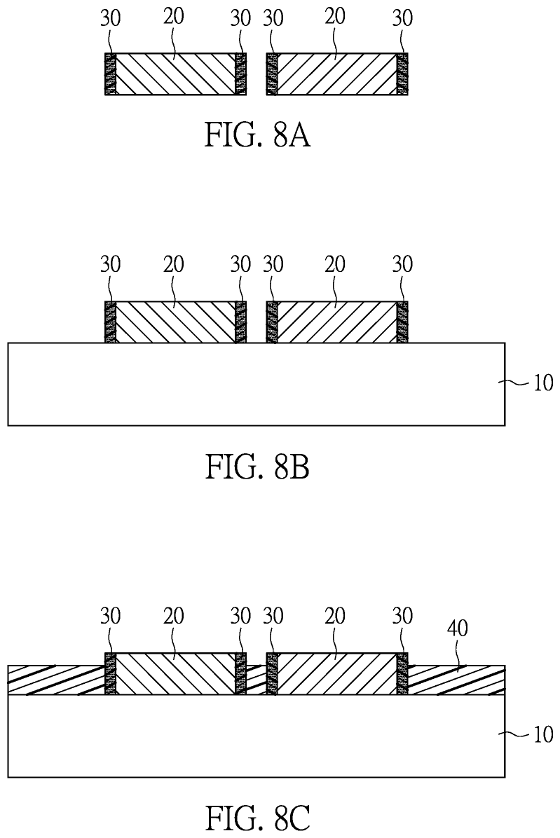

Referring to FIG. 8A to FIG. 8C, a seventh embodiment of the present disclosure provides a method for manufacturing a thermally conductive and electrically insulating substrate structure, including the steps of:

(a) attaching a plurality of function layers 30 to sidewalls of a plurality of metal layers 20;

(b) attaching the plurality of metal layers 20 to an insulating layer 10; and

(c) attaching a framework 40 between any two adjacent ones of the function layers 30 and to the insulating layer 10.

Further, the attaching method can be a physical bonding or a chemical molding method. In addition, under the circumstances that the framework 40 does not need to be removed, the functional layer 30 in the present embodiment can be made of a high-binding polymeric material and the framework 40 can be made of a non-metallic material with a low electrical conductivity.

It should be noted that the above is to describe the differences between the present embodiment and other embodiments, and similarities therebetween will not be repeated.

### Beneficial Effects of the Embodiments

In conclusion, the thermally conductive and electrically insulating substrate structure provided by the present disclosure can effectively reduce the probability of short circuit by virtue of “the plurality of metal layers and the plurality of function layers being disposed on the insulating layer, a sidewall of the metal layer being in contact with a corresponding one of the function layers, and two of the function layers between any two adjacent ones of the metal layers not being in contact with each other.”

The foregoing description of the exemplary embodiments of the disclosure has been presented only for the purposes of illustration and description and is not intended to be exhaustive or to limit the disclosure to the precise forms disclosed. Many modifications and variations are possible in light of the above teaching.

The embodiments were chosen and described in order to explain the principles of the disclosure and their practical application so as to enable others skilled in the art to utilize the disclosure and various embodiments and with various modifications as are suited to the particular use contemplated. Alternative embodiments will become apparent to those skilled in the art to which the present disclosure pertains without departing from its spirit and scope.

What is claimed is:

1. A thermally conductive and electrically insulating substrate structure, comprising an insulating layer, a plurality of metal layers and a plurality of function layers; wherein the plurality of metal layers and the plurality of function layers are disposed on the insulating layer, a sidewall of the metal layer is in contact with a corresponding one of the function layers, and two of the function layers between any two adjacent ones of the metal layers are not in contact with each other.

2. The thermally conductive and electrically insulating substrate structure according to claim 1, wherein the function layer is made of a highly insulating material.

3. The thermally conductive and electrically insulating substrate structure according to claim 1, wherein the function layer is made of a polymeric material.

4. The thermally conductive and electrically insulating substrate structure according to claim 1, wherein the function layer is made of a low-binding polymeric material.

5. The thermally conductive and electrically insulating substrate structure according to claim 1, wherein the function layer is made of a corrosion resistant material.

6. The thermally conductive and electrically insulating substrate structure according to claim 1, wherein the function layer is a composite layer, which includes a ceramic layer formed on the sidewall of the metal layer and a polymer layer formed on a sidewall of the ceramic layer, and the polymer layer is made of a low-binding polymeric material.

7. A thermally conductive and electrically insulating substrate structure, comprising an insulating layer, a plurality of metal layers, a plurality of function layers and a framework; wherein the plurality of metal layers, the plurality of function layers and the framework are disposed on the insulating layer, a sidewall of the metal layer is in contact with a corresponding one of the function layers, and two of the function layers between any two adjacent ones of the metal layers are in contact with the framework.

8. The thermally conductive and electrically insulating substrate structure according to claim 7, wherein the function layer is made of a highly insulating material.

9. The thermally conductive and electrically insulating substrate structure according to claim 7, wherein the function layer is made of a polymeric material.

10. The thermally conductive and electrically insulating substrate structure according to claim 7, wherein the function layer is made of a high-binding polymeric material.

11. The thermally conductive and electrically insulating substrate structure according to claim 7, wherein the function layer is made of a corrosion resistant material.

12. The thermally conductive and electrically insulating substrate structure according to claim 7, wherein the function layer is a composite layer, which includes a ceramic layer formed on the sidewall of the metal layer and a polymer layer formed on a sidewall of the ceramic layer, and the polymer layer is made of a high-binding polymeric material.

13. The thermally conductive and electrically insulating substrate structure according to claim 7, wherein the framework is made of a non-metallic material with a low electrical conductivity.

14. A method for manufacturing a thermally conductive and electrically insulating substrate structure, comprising steps of:
(a) attaching a plurality of function layers to sidewalls of a plurality of metal layers;
(b) attaching a framework between any two adjacent ones of the function layers; and
(c) attaching the framework and the plurality of metal layers on an insulating layer.

15. The method according to claim 14, further comprising a step (d): removing the framework.

16. The method according to claim 15, wherein, in the step (d), the framework is removed by corrosion, and the function layer is made of a corrosion resistant material.

17. The method according to claim 15, wherein, in the step (d), the framework is removed by peeling, and the function layer is made of a low-binding polymeric material.

18. The method according to claim 14, wherein the function layer is a composite layer, which includes a ceramic layer formed on the sidewall of the metal layer and a polymer layer formed on a sidewall of the ceramic layer.

19. The method according to claim 14, wherein the framework is made of a non-metallic material with a low electrical conductivity.

20. The method according to claim 14, wherein a manner of attachment is by physical bonding or chemical molding.
